(19) United States
(12) Patent Application Publication
(10) Pub. No.: US 2010/0295892 A1
(43) Pub. Date: Nov. 25, 2010

(54) METHOD OF CLEANING A SCRAPER DEVICE

(75) Inventors: Ramón Riera Garriga, Girona (ES); Lluís Puigdemont Camos, Girona (ES)

Correspondence Address: HESS PATENT LAW FIRM, P.C., 9 MIRAMAR LANE, STAMFORD, CT, 06902, US

(73) Assignee: COMEXI GROUP INDUSTRIES, S.A., Girona (ES)

(21) Appl. No.: 12/783,089

(22) Filed: May 19, 2010

Related U.S. Application Data
(63) Continuation of application No. PCT/ES2008/000648, filed on Oct. 17, 2008.

(30) Foreign Application Priority Data
Nov. 19, 2007 (ES) P200703048

(51) Int. Cl. B41J 2/165

(52) U.S. Cl. 347/28

(57) ABSTRACT

The invention relates to a method of cleaning doctor devices (10) of inking units in a printer, comprising emptying the ink from an ink chamber, through feed (11) and drainage (12) tubes, into an ink tank (13) and supplying solvent into said ink chamber, followed by emptying said solvent form the ink chamber, carrying out all of said actions by using a dynamic fluid pump (15), with a first and second diaphragms of different sizes, one of the faces thereof defining respective pumping (15a) and suction (15b) chambers, said suction chamber (15b) having a greater volumetric capacity. In said method the ink is circulated for emptying by means of said pumping (15a) and suction (15b) chambers, the former being used in reverse, and solvent is supplied by entering said pumping chamber (15a) and exiting through said suction chamber (15b).

### FIELD OF THE ART

The present invention relates to a method of cleaning doctor devices for inking units in a printer, comprising emptying the ink from an ink chamber of at least one doctor device, through feed and drainage tubes, into an ink tank and supplying solvent into said ink chamber from a solvent tank, followed by emptying said solvent from the ink chamber, carrying out all of said actions by using at least one dynamic fluid pump connected, through said feed and drainage tubes, to said ink chamber, to aspirate the ink from therein and introduce solvent therein.

### STATE OF THE ART

Methods of cleaning doctor devices for inking mechanisms in printers are known which use the circulation of solvent inside the ink chamber corresponding to said doctor device, using at least one dynamic fluid pump for pumping and aspirating said solvent through the feed and drainage tubes, respectively. Thus, methods of cleaning having these features are described in patents EP-780228-B1 and U.S. Pat. No. 5,402,724.

Specifically, patent EP-780228 describes a cycle comprising several steps in which after emptying ink from the ink chamber, solvent is pumped into the ink chamber, leading said solvent in a first step, and for a pre-established time, into an ink tank and in subsequent steps into a dirty solvent tank. One of the steps described in said patent comprises circulating solvent for a pre-established time in a closed washing circuit through the feed and drainage tubes. It has been observed that this method requires a very accurate control of the ink that is returned to the ink deposit together with the solvent before sending the solvent to the dirty solvent tank.

In turn, patent U.S. Pat. No. 5,402,724 describes a process in which the direction of the pumped solvent during the washing step through the ink chamber is reversed several times. As a result of this change of solvent flow direction, better cleaning of the ink chamber is achieved.

The present invention proposes a new technology which obtains a better cleaning since it forces the solvent to circulate under pressure, carried out in a method of cleaning doctor devices for inking mechanisms in printers, circulating solvent therethrough by means of a double diaphragm dynamic fluid pump, with one of the diaphragms having a diameter greater than the other one, such that the volume of fluid displaced by the chamber of the diaphragm having the larger diameter is greater than the volume displaced by the chamber having the smaller diameter, by using this pump during the cleaning cycle according to predetermined conditions.

### BRIEF DESCRIPTION OF THE INVENTION

The present invention describes a method of cleaning doctor devices for inking mechanisms in a printer, particularly applicable to a flexographic printer, comprising emptying the ink from an ink chamber of at least one doctor device, through feed and drainage tubes, into an ink tank and supplying solvent into said ink chamber from a solvent tank, followed by emptying said solvent from the ink chamber, carrying out all of said actions by using at least one dynamic fluid pump connected, through said feed and drainage tubes, to said ink chamber, to aspirate the ink from therein and introduce solvent. In the invention, said dynamic fluid pump comprises a first and second diaphragms of different sizes attached to one another, one of the faces thereof defining with respect to a wall of the pump respective pumping and suction chambers suitable for containing at least one fluid to be displaced, the suction chamber having a greater volumetric capacity.

The ink is circulated for a first emptying by means of said pumping and suction chambers, the former being used in reverse, since the ink is emptied through both the feed and the drainage tubes.

In addition, the solvent is supplied by circulating said solvent, it entering said pumping chamber and exiting through said suction chamber, after which, in a first step, the solvent accesses an intermediate deposit at atmospheric pressure and from said intermediate deposit it passes to a dirty solvent tank.

For a preferred embodiment, the proposed method of cleaning is applicable, in a manner analogous to what has been explained above, to the cleaning of a plurality of doctor devices, each of said devices belonging to a respective printing unit of said printer, each printing unit using ink of a different color.

For said preferred embodiment, the method comprises using for the cleaning of each of said doctor devices a respective dynamic fluid pump analogous to that previously described, i.e., with a first and second diaphragms of different sizes, connected to the respective ink chamber thereof through corresponding feed and drainage tubes and the corresponding ink tank thereof, a single common solvent tank and a single common dirty solvent tank being used for the cleaning of all of them. The use of said common dirty solvent tank for discharging the dirty solvent coming from each doctor device could cause, due to back-pressures, fluid to circulate in some of the discharge circuits in the direction opposite to the discharge direction, i.e., from the dirty solvent tank, which would cause an unwanted contamination of said circuit and of its corresponding doctor device. The use of said intermediate deposit at atmospheric pressure has been provided in order to prevent said back-pressures in discharging the dirty solvent of each of the different doctor devices.

In a second step, the circulation of solvent to said intermediate deposit is interrupted and the solvent remaining in the tubes is recirculated for a pre-established time in a closed washing circuit through the feed and drainage tubes, said closed circuit being, since the mentioned pump with two diaphragms of different sizes is used, under greater suction than pumping conditions due to the greater volumetric capacity of the suction chamber of the dynamic fluid pump. This greater suction assures that all the pumped solvent is aspirated, even though it also causes an increase of pressure inside the circuit, so during said second step it has been provided to do some briefly circuit opening actions to release pressure.

In a third step, said recirculated solvent is pumped towards said dirty solvent tank.

The method of cleaning of the present invention is characterized in that at least one cycle comprising said first, second and third steps is performed.

### BRIEF DESCRIPTION OF THE DRAWINGS

The previous and other advantages and features will be more fully understood from the following detailed description of some embodiments in relation to the attached drawings, which should be interpreted in an illustrative and non-limiting manner, in which:

FIG. 1 shows a diagram of the circuit corresponding to the method of cleaning of the present invention.

### DETAILED DESCRIPTION OF AN EMBODIMENT

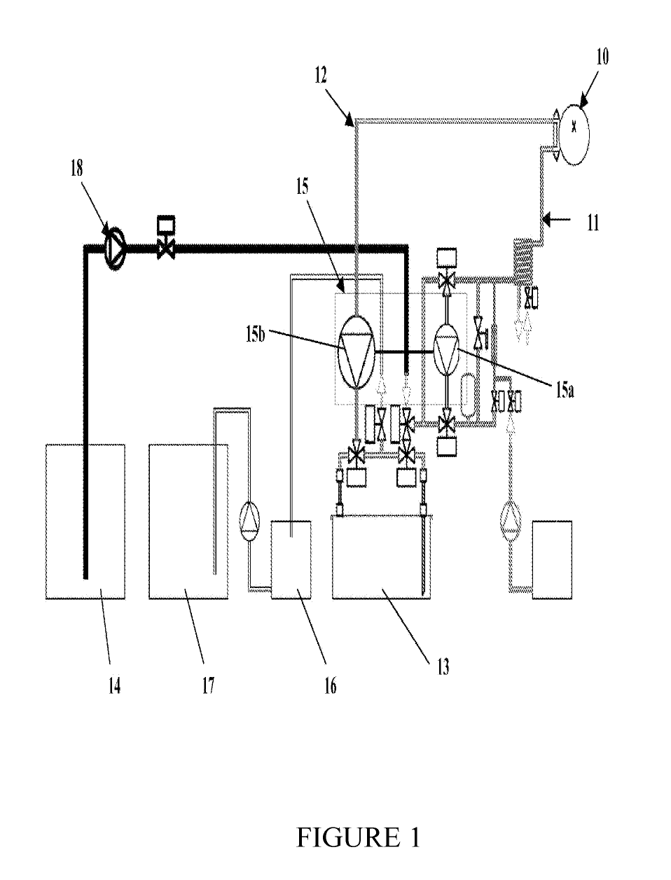

FIG. 1 is a diagram of a circuit corresponding to the method of cleaning a doctor device 10 for an inking mechanism in a flexographic printer. This method comprises emptying the ink from an ink chamber of at least one doctor device 10 through feed 11 and drainage 12 tubes, into an ink tank 13 and supplying solvent into said ink chamber from a solvent tank 14, followed by emptying said solvent from the ink chamber, carrying out all of said actions by using at least one dynamic fluid pump 15 connected, through said feed 11 and drainage 12 tubes, to said ink chamber, to aspirate the ink from therein and introduce solvent. FIG. 1 shows the dynamic fluid pump 15 with a dotted line, and it can be seen therein that said pump 15 is a double diaphragm pump in which one of the two diaphragms has a larger diameter than the other one. Specifically, the diaphragm corresponding to the suction chamber 15b is larger than the one corresponding to the pumping chamber 15a, so the volume displaced by said suction chamber 15b is greater than the volume displaced by the pumping chamber 15a.

In the method of cleaning of the present invention, the ink is circulated for emptying by means of said pumping 15a and suction 15b chambers, the former being used in reverse, such that the ink is emptied through both the drainage and the feed tubes.

With respect to supplying solvent, it is supplied by circulating said solvent from a solvent tank 14, it entering said pumping chamber 15a and exiting through said suction chamber 15b.

In the embodiment shown in FIG. 1, the solvent is circulated from said solvent tank 14 to the pumping chamber 15a of the dynamic fluid pump 15 by means of the cooperation of a second pump 18, although in another embodiment in which the solvent tank is closer to the dynamic fluid pump 15, the pumping chamber 15a of said dynamic fluid pump 15 is capable of capturing the solvent directly from said solvent tank 14.

In said embodiment shown in FIG. 1, the cleaning circuit corresponding to a single doctor device 10 has been depicted, the proposed method of cleaning being applicable, for a preferred embodiment and in a manner analogous to what has been explained above, to the cleaning of a plurality of doctor devices, each of said devices belonging to a respective printing unit of said printer, each printing unit using ink of a different color.

For said preferred embodiment, the method comprises using for the cleaning of each of said doctor devices 10 a respective pump analogous to said dynamic fluid pump 15, connected to the respective ink chamber thereof through corresponding feed and drainage tubes, analogous to said feed 11 and drainage 12 tubes and the corresponding ink tank thereof analogous to said ink tank 13, said solvent tank 14 being used as a single common solvent tank, said intermediate deposit 16 as a single common deposit for the intermediate discharge of the dirty solvent coming from all the doctor devices, and said dirty solvent tank 17 also as a single common tank for the final discharge of said dirty solvent. The use of said intermediate deposit prevents, as mentioned above, unwanted back-pressures during said discharge of dirty solvent coming from the different doctor devices.

It has generally been provided that the dynamic fluid pump 15 is furthermore used in an inking process, said inking process consisting of supplying ink to the ink chamber through said pumping chamber 15a and in aspirating said ink through said suction chamber 15b.

A person skilled in the art will be able to introduce changes and modifications in the embodiments described without departing from the scope of the invention as it is defined in the attached claims.

1. A method of cleaning doctor devices of inking units in a printer, comprising:
emptying the ink from an ink chamber of at least one doctor device, through feed and drainage tubes, into an ink tank,
supplying solvent into said ink chamber from a solvent tank, and emptying said solvent from the ink chamber,
wherein all of said actions are carried out by using at least one dynamic fluid pump connected, through said feed and drainage tubes, to said ink chamber, to aspirate the ink from therein and introduce solvent therein,
wherein said dynamic fluid pump comprises first and second diaphragms of different sizes attached to one another, one of the faces thereof defining with respect to a wall of the pump respective pumping and suction chambers suitable for containing at least one fluid to be displaced, said suction chamber having a greater volumetric capacity, and
wherein the ink is circulated for emptying by means of said pumping and suction chambers, the former being used in reverse, and the solvent is supplied by circulating said solvent, it entering said pumping chamber and exiting through said suction chamber.

2. The method of cleaning according to claim 1, comprising a first step where the solvent, after circulating entering through the pumping chamber and exiting through the suction chamber, accesses an intermediate deposit at atmospheric pressure, and from said intermediate deposit it passes to a dirty solvent tank.

3. The method of cleaning according to claim 2, comprising a second step where the circulation of solvent to said intermediate deposit is interrupted and the solvent remaining in the tubes for a pre-established time in a closed washing circuit is recirculated through the feed and drainage tubes, said closed circuit being under greater suction than pumping conditions.

4. The method of cleaning according to claim 3, comprising, during said second step, to do some briefly circuit opening actions to release pressure.

5. The method of cleaning according to claim 3, comprising a third step where said recirculated solvent is pumped towards said dirty solvent tank.

6. The method of cleaning according to claim 5, further comprising performing at least one cycle comprising said first, second and third steps.

7. The method of cleaning according to claim 1, comprising circulating the solvent from said solvent tank to the pumping chamber of the dynamic fluid pump by means of the cooperation of a second pump.

8. The method of cleaning according to claims 2, wherein it is applied to the cleaning of a plurality of doctor devices, each of them comprising a respective pump analogous to said dynamic fluid pump, connected to the respective ink chamber thereof through corresponding feed and drainage tubes, analogous to said feed and drainage tubes and the corresponding ink tank thereof analogous to said ink tank, said solvent tank being used as a single common solvent tank and said dirty solvent tank also as a single common tank for discharging the dirty solvent coming from all the doctor devices.

9. The method of cleaning according to claim 8, comprising using said intermediate deposit as a common deposit for the intermediate discharge, before discharging the dirty solvent coming from all the doctor devices into the dirty solvent tank, for the purpose of preventing unwanted back-pressures during said discharge.

10. The method of cleaning according to claim 1, wherein said dynamic fluid pump is furthermore used in an inking process, said inking process consisting of supplying ink to the ink chamber through said pumping chamber and of aspirating said ink through said suction chamber.
